(19) United States
(12) Patent Application Publication
(10) Pub. No.: US 2015/0282513 A1
(43) Pub. Date: Oct. 8, 2015

(54) SWEETENER SYRUPS

(71) Applicant: TATE & LYLE INGREDIENTS AMERICAS, LLC, Hoffman Estates, IL (US)

(72) Inventors: Shondra Cook, Elgin, IL (US); Joshua Nehemiah Fletcher, Algonquin, IL (US); James Michael Gaddy, Crystal Lake, IL (US); Yuqing Zhou, Hoffman Estates, IL (US)

(73) Assignee: Tate & Lyle Ingredients Americas LLC, Hoffman Estates, IL (US)

(21) Appl. No.: 14/438,364

(22) PCT Filed: Oct. 25, 2013
(86) PCT No.: PCT/US13/66726

§ 371 Date: Apr. 24, 2015

Related U.S. Application Data
(60) Provisional application No. 61/718,944, filed on Oct. 26, 2012.
(60) Provisional application No. 61/767,302, filed on Feb. 21, 2013.

(51) Int. Cl. A23L 1/236

(52) U.S. Cl. CPC A23L 1/2364; A23L 1/2363; A23V 2002/00

(57) ABSTRACT

A sweetener syrup containing glucose, a stabilizer selected from the group consisting of DP2 to DP10 saccharides, sugar alcohols, monosaccharides other than glucose and mixtures thereof, and flavor enhancer is resistant to crystallization and has viscosity and sweetness comparable to that of high fructose corn syrups and may be used as a substitute for high fructose corn syrups in foods and beverages.

### FIELD OF THE INVENTION

The invention pertains to sweetener syrups useful as functional substitutes for high fructose corn syrups in foods, beverages and the like.

### BACKGROUND OF THE INVENTION

High fructose corn syrup has been used for many years as an ingredient in various food, beverage and pharmaceutical compositions. In addition to imparting sweetness to such compositions, high fructose corn syrup also serves as a bulking agent and provides various other useful and advantageous properties.

Many retail products currently contain high fructose corn syrup (HFCS). Due to negative consumer perceptions regarding HFCS, many food companies are currently seeking alternatives for sweetening their products that avoid the need to label the product as containing HFCS. Since HFCS is widely used and product formulations and processing operations have been established using HFCS as a key ingredient, food manufacturers would be quite interested in identifying sweetener products that could replace HFCS on a one-to-one basis and that would avoid the need to change ingredient handling procedures or the product formulation.

Glucose syrups containing glucose as the predominant or exclusive saccharide present in the syrup are currently available on the market which can, in principle, be used as sweeteners. However, such glucose syrups are not as sweet as HFCS and also suffer from the disadvantage of crystallizing upon prolonged storage at ambient to slightly elevated temperatures, making them difficult to handle.

### SUMMARY OF THE INVENTION

One aspect of the invention provides a sweetener syrup comprising water and glucose and having a dry solids content of from 69% to 73% by weight, additionally comprising an amount of a stabilizer such as a DP2 to DP10 saccharide (e.g., sucrose, maltose, maltotriose, maltotetraose), sugar alcohol, or monosaccharide other than glucose effective to inhibit crystallization of the sweetener syrup and an amount of one or more flavor enhancers at sub-sweetening level effective to increase the perception of sweetness of the sweetener syrup, wherein the sweetener syrup is comprised of from 0 to not more than 5 weight % fructose on a dry solids basis. The stabilizer(s) may, for example, constitute from 25 to 60 weight % of the glucose and stabilizer combined. The invention thus furnishes a high-sweetness, low viscosity, storage stable sweetener capable of being used as a replacement for high fructose corn syrup in a variety of end-use applications.

Another aspect of the invention provides a food, beverage or pharmaceutical composition comprising the above-mentioned sweetener syrup and at least one additional food, beverage or pharmaceutical ingredient.

Yet another aspect of the invention provides a method of making a sweetener syrup, comprising combining one or more stabilizers selected from the group consisting of DP2 to DP10 saccharides, sugar alcohols and monosaccharides other than glucose and one or more flavor enhancers with a glucose syrup, wherein an amount of stabilizer is used which is effective to inhibit crystallization of the sweetener syrup, an amount of flavor enhancer is used which is effective to increase the perception of sweetness of the sweetener syrup, and the resulting sweetener syrup has a dry solids content of 69% to 73% by weight and is comprised of from 0 to not more than 5 weight % fructose on a dry solids basis.

### DETAILED DESCRIPTION OF CERTAIN EMBODIMENTS OF THE INVENTION

In addition to water, which is present in an amount effective to provide a dry solids content of 69 to 73 weight percent (in another embodiment, a dry solids content of 70 to 72 weight percent), glucose is present in the sweetener syrups of the present invention. The glucose (also known as dextrose) may be provided from any suitable source. Although crystalline glucose may be employed, for convenience and for economic reasons the source of glucose may be a glucose syrup (e.g., a relatively concentrated solution of glucose in water). Glucose syrups are well-known in the art and are also readily available from commercial sources. For example, the glucose syrups sold by Tate & Lyle under the brand name STALEYDEX may be utilized. Typically, glucose constitutes from 40 to 75% of the weight of the glucose and stabilizer combined. That is, glucose represents 40 to 75% of the total weight of glucose and stabilizer present in the sweetener syrup of the invention. In one embodiment, the sweetener syrup contains 27 to 56 weight % glucose.

To assist in suppressing the tendency of the glucose to crystallize from the sweetener syrup upon prolonged storage at ambient to somewhat elevated temperatures, an amount of one or more stabilizers is also incorporated into the syrup. The stabilizer may be, for example, a DP2 to DP10 saccharide (a saccharide having a degree of polymerization of from 2 to 10) or mixture of two or more such saccharides. Such di- and oligosaccharides are well known in the art and include, for example, sucrose, maltose, maltotriose, maltotetraose and the like and mixtures thereof. Other suitable DP2 to DP10 saccharides include trehalose and raffinose. DP2 to DP10 saccharides are available from numerous commercial sources, including Tate & Lyle Ingredients Americas. The DP2 to DP10 saccharides may be conveniently provided to the sweetener syrups of the present invention in the form of syrups or, alternatively, in dry form.

Sugar alcohols are also useful as the stabilizer component of the present invention. Sugar alcohols are polyhydric alcohols containing more than three or more hydroxyl groups per molecule and may correspond to the general formula HOCH₂(CHOH)ₙCH₂OH, where n is an integer from 1 to 5. Examples of suitable sugar alcohols include glycerol, erythritol, pentaerythritol, threitol, arabitol, xylitol, ribitol, mannitol, sorbitol, galactitol, iditol, inositol, volemitol, isomalt, maltitol, lactitol, polyglycitol and mixtures thereof.

The stabilizer used in the present invention may also suitably be a monosaccharide other than glucose, including C4-C7 monosaccharides such as erythrose, erythrulose, threose, arabinose, ribose, ribulose, xylose, xylulose, lyxose, allose, altrose, psicose, galactose, gulose, idose, mannose, sorbose, talose, tagatose, sedoheptulose and mannoheptulose and mixtures thereof.

Mixtures of any of the foregoing types of substances may also be used as the stabilizer in the present invention.

The sweetener syrup contains little or no fructose (also known as levulose). For example, the sweetener syrup may be comprised of not more than 5 weight % fructose, or not more than 1 weight % fructose, on a dry solids basis. The sweetener syrup may, in one embodiment, be free of fructose.

The syrup is formulated to contain an amount of stabilizer sufficient to inhibit crystallization, i.e., to reduce the amount of crystallization which occurs over time as compared to an analogous syrup which does not contain stabilizer. The amount of stabilizer present in the syrup may be selected so as to be effective in preventing crystallization of the sweetener syrup for at least one week when maintained at a temperature of 37° C. In other embodiments, the amount of stabilizer present in the syrup is selected so as to be effective in preventing crystallization of the sweetener syrup for at least two weeks, or at least one month, or at least two months, or at least three months, or at least four months, or at least five months, or at least six months when maintained at a temperature of 37° C. In still other embodiments, the amount of stabilizer present in the syrup is selected so as to be effective in preventing crystallization of the sweetener syrup for at least one week, or at least two weeks, or at least one month, or at least two months, or at least three months, or at least four months, or at least five months, or at least six months when maintained at a temperature of 25° C. Typically, the stabilizer content constitutes from 25 to 60 weight % of the glucose and stabilizer combined. That is, the total amount of stabilizer(s) represents 25 to 60 percent of the total weight of glucose and stabilizer present in the sweetener syrup of the invention.

In order to maintain a favorably low viscosity in the sweetener syrup, it will generally be advantageous to minimize the level of higher saccharides present in the syrup. For example, in various embodiments of the invention, the syrup contains not more than 10 weight %, not more than 8 weight %, not more than 5 weight %, not more than 2 weight %, or not more than 1 weight % (on a dry solids basis) in total of DP11+saccharides (saccharides having a degree of polymerization of 11 or greater). In one embodiment, the sweetener syrup contains no or essentially no DP11+saccharide. In other embodiments, the syrup contains not more than 20 weight %, not more than 10 weight %, not more than 8 weight %, not more than 5 weight %, not more than 2 weight %, or not more than 1 weight % (on a dry solids basis) in total of DP6+saccharides (saccharides having a degree of polymerization of 6 or greater). In other embodiments, the sweetener syrup contains no or essentially no DP6+saccharide.

In one embodiment, the sweetener syrup has a viscosity at 20° C. of 0.2 to 0.45 Pa·s and a viscosity at 37° C. of 0.05 to 0.15 Pa·s.

In another embodiment, the sweetener syrup has a viscosity profile comparable to that of HFCS 42 (high fructose corn syrup having a fructose content of 42 weight percent on a dry solids basis).

The sweetener syrup of the present invention further contains one or more substances capable of acting as flavor enhancers to improve the perceived sweetness of the syrup. That is, the concentration of such a flavor enhancer is below the minimum level where, if no other sweet substance such as a sugar is present in a composition, a person perceives the composition containing the flavor enhancer substance(s) as having a sweet taste (sometimes referred to as the sweetness detection threshold). The flavor enhancer is a substance other than a saccharide, although the flavor enhancer may contain one or more saccharide moieties chemically bound to other moieties (as in the case of a glycoside, for example). The flavor enhancer(s) are typically present in relatively low levels, e.g., not more than 2 weight %, not more than 1 weight %, not more than 0.8 weight %, not more than 0.5 weight %, not more than 0.3 weight %, not more than 0.2 weight % total of the syrup, on a dry weight basis. Generally, the sweetener syrup will contain at least 0.001 weight total of flavor enhancer, on a dry weight basis. In one embodiment, the sweetener syrup comprises from 0.001 to 2 weight %, on a dry solids basis, of flavor enhancer

Suitable flavor enhancers include, but are not limited to, substances which are natural high intensity sweeteners. Such substances include mogrosides (e.g., mogroside V) as well as extracts containing one or more mogrosides such as monk fruit (luo han guo) extracts, steviol glycosides such as steviosides and rebaudiosides (e.g., rebaudioside A, rebaudioside B, rebaudioside C) as well as extracts containing one or more rebaudiosides such as Stevia extracts), glycosylated steviol glycosides (such as those obtained by enzymatic glycosylation of mixtures of semi-purified steviol glycosides), rubusoside (which may be supplied in the form of a Rubus extract), and the like and mixtures thereof. Other exemplary suitable flavor enhancers useful in the present invention include natural and artificial substances such as neohesperidin dihydrochalcone, neotame, glycyrrhizin and its salts and derivatives (e.g., ammoniated glycyrrhizin), aspartame, saccharin, thaumatin, monatin, sucralose, acesulfame potassium and the like and mixtures thereof (including mixtures with any of the aforementioned natural high intensity sweeteners).

In addition to the one or more flavor enhancers, the syrups of the present invention may additionally contain one or more additional additives such as, for example, preservatives, stabilizers, pH adjusting agents (acids, bases), buffers and the like.

The sweetener syrups of the present invention may be prepared by combining one or more stabilizers selected from the group consisting of DP2 to DP10 saccharides, sugar alcohols and monosaccharides other than glucose and one or more flavor enhancers with a glucose syrup, wherein an amount of stabilizer is used which is effective to inhibit crystallization of the sweetener syrup, an amount of flavor enhancer is used which is effective to increase the perceived sweetness of the sweetener syrup at a sub-sweetening level, and the resulting sweetener syrup has a dry solids content of 69% to 73% by weight. The stabilizer(s) and flavor enhancer(s) may be added, separately or together, to the glucose syrup and the resulting mixture processed (by mixing or stirring in a tank, for example) to provide a sweetener syrup that is homogeneous. The components and/or the mixture of components may be heated. It may be convenient to dissolve the stabilizer(s) and/or flavor enhancers in water before these components are combined with the glucose syrup. The stabilizer (e.g., DP2 to DP10 saccharide(s)) may be supplied in the form of a syrup, such as a high maltose syrup. The total amount of water which is introduced is selected and controlled so as to provide a dry solids content in the sweetener syrup of from 69% to 73% by weight. In one embodiment of the invention, an excess of water is employed when the components are combined, with a quantity of water thereafter being removed to achieve the desired dry solids content. In another embodiment of the invention, a quantity of water is employed to dissolve stabilizer(s) with heat and the dissolved flavor enhancer(s) and stabilizer(s) are then combined with glucose syrup, with an additional quantity of water thereafter being added to achieve the desired dry solids content. In another embodiment of the invention, glucose syrup and stabilizer(s) are first mixed together to form a homogenous syrup. A quantity of water is employed to dissolve flavor enhancer(s) without heat and the dissolved flavor enhancer(s) is then combined with syrup, with an additional quantity of water thereafter being added to achieve the desired dry solids content.

The syrup of the present invention can be utilized in food, beverage, animal feed, animal health and nutrition, pharmaceutical, and cosmetic products. The syrup may be used in foods and feeds to soften texture, add volume, thicken, prevent crystallization of sugar, and/or enhance flavor or sweetness. For example, the syrup may be substituted in whole or in part for the high fructose corn syrup component of a food product.

In particular, the syrup is useful as a bulking agent. It is capable of having an appearance, viscosity, crystallinity, mouthfeel, humectancy, sweetness and other colligative properties similar to those of conventional corn syrups. As such, it can be readily substituted on an approximately equal weight or volume basis for conventional high fructose corn syrups in food, beverage, animal feed, animal health and nutrition, pharmaceutical, cosmetic products and the like. The syrups of the present invention thus can be utilized to remove high fructose corn syrup from a product without significantly altering the physical and sensory attributes of the product.

Non-limiting examples of the utility of the sweetener syrup of this invention include its use as bulking, binding and coating ingredients; carriers for coloring agents, flavors/fragrances, and high intensity sweeteners; spray drying adjuncts; bulking, bodying and dispersing agents; and ingredients promoting moisture retention (humectants). Illustrative examples of products which can be prepared using the syrups described herein include food products, beverage products, pharmaceutical products, nutritional products, sports products and cosmetic products. Particular types of products which may comprise sweetener syrups in accordance with the present invention include beverage products such as concentrated beverage mixes, carbonated beverages, non-carbonated beverages, fruit-flavored beverages, fruit juices, teas, coffee, milk nectars, powdered soft drinks. Liquid concentrates, milk drinks, smoothies, alcoholic beverages, flavored waters and combinations thereof. Food products in accordance with the present invention include, for example, baked goods (e.g., breads), confectioneries (confectionery products), frozen dairy products, meats, cereal products (e.g., breakfast cereals), dairy products (e.g., yogurt), condiments, snack bars, soups, dressings, mixes, prepared foods, baby foods, diet preparations, peanut butter, syrups, sweeteners, food coatings, pet food, animal feed, animal health and nutrition products, dried fruit, sauces, gravies, jams/jellies, dessert products, meats, condiments, spreads, batters, breadings, spice mixes, frostings and the like. The sweetener syrup is combined with one or more other ingredients, such as a food, beverage or pharmaceutical ingredient, to provide a food, beverage or pharmaceutical composition.

### EXAMPLES

The following materials (all commercially available products) were used to prepare the various sweetener syrups described in the Examples:

| Material | Description | Chemical composition |
|---|---|---|
| Material A | Glucose syrup | ≧95% dextrose d.s.b.¹ |
| Material B | Monk fruit extract | 48-52% mogroside V d.s.b. |
| Material C | High fructose corn syrup | ≧42% fructose d.s.b. |
| | 42 | ≧93% total monosaccharides d.s.b. |
| Material D | Crystalline dextrose | ≧99% dextrose d.s.b. |
| | (glucose) | |
| Material E | High DE corn syrup | 63% D.E.² (~37% dextrose, ~29% |
| | | maltose, ~9% maltotriose, ~25% |
| | | higher saccharides d.s.b.) |
| Material F | High maltose corn syrup | 50% D.E. (~10% dextrose, ~42% |
| | | maltose, ~22% maltotriose, ~26% |
| | | higher saccharides d.s.b.) |
| Material G | Soluble corn fiber | ≧85% soluble fiber d.s.b. |
| Material H | Low DE corn syrup | 26% D.E. (~5% dextrose, ~8% |
| | | maltose, ~11% maltotriose, ~76% |
| | | higher saccharides d.s.b.) |

d.s.b¹: dry solids base
D.E.²: dextrose equivalent

### Example 1

Material A was mixed with dry sucrose and flavors in accordance with Table 1 (the amounts stated are in weight percent). The sum of % DSB (dry solids base) of sucrose, flavors and Material A was 100%. To ease the dissolution, the sucrose and flavors were first dissolved in water at about 55° C. before adding to Material A. The final solids content of the syrups was targeted at 71% by weight.

TABLE 1
Syrup compositions

| | Syrup 1-1 | Syrup 1-2 | Syrup 1-3 |
|---|---|---|---|
| Material A, % | 74.967 | 74.968 | 74.970 |
| Sucrose, % | 25 | 25 | 25 |
| Material B, % | 0.0249 | 0.0210 | 0.0166 |
| Rebaudioside A, % | 0.0084 | 0.0105 | 0.0126 |
| Total % | 100 | 100 | 100 |

Once the syrups were ready, the solutions for sensory test were prepared from Material C and the Syrup 1-1, 1-2 and 1-3 compositions (Table 2). The solutions were prepared by weighing the syrup and adding water to bring the weight to the specified amount. The solutions were then tested for ° Brix on an ATAGO RX-5000 refractometer.

TABLE 2
Solutions for sensory evaluation

| INGREDIENT | % | % | % | % |
|---|---|---|---|---|
| Material C | 14.16 | 0 | 0 | 0 |
| Syrup 1-1 | 0 | 14.063 | 0 | 0 |
| Syrup 1-2 | 0 | 0 | 13.949 | 0 |
| Syrup 1-3 | 0 | 0 | 0 | 13.949 |
| water | 85.84 | 85.937 | 86.051 | 86.051 |
| TOTAL | 100 | 100 | 100 | 100 |
| Brix | 9.97 | 10.06 | 10.04 | 9.93 |

Paired comparison tests for sweetness were conducted in neutral pH water. The tests were conducted as complete block designs. The presentation order and reference were rotated. The solutions were served in 2 ounce soufflé cups at room temperature. The panelists were instructed to consume at least half of each sample. The panelists were asked to identify which of the samples labeled with a 3-digit code was sweeter. Bottled water and unsalted crackers were available for the panelists to clear their palates before and during testing. The results were analyzed by binomial test at an alpha of 0.05 as two tailed tests.

Table 3 summarizes the sweetness evaluation results obtained for the syrups having the compositions set forth in Table 1. The numbers in the table are the number of panelists who chose the sweeter sample.

TABLE 3
Sensory results for Example 1

| | Syrup 1-1 | Syrup 1-2 | Syrup 1-3 |
|---|---|---|---|
| | 14.06% solids | 13.95% solids | 13.95% solids |
| Material C | 29 | 21 | 23 |
| Syrup | 7 | 15 | 13 |
| Two tailed p-value | <0.01 | 0.24 | 0.07 |

Syrup 1-2, containing 315 ppm of Material B and Rebaudioside A used as flavors to create a more sugar-like taste profile in the ratio of 2:1, was not significantly different from Material C at 10° Brix (p-value 0.24).

Syrup 1-3, containing 292 ppm of Material B and Rebaudioside A used as flavors to create a more sugar-like taste profile in the ratio of 1.32:1, was not significantly different from Material C at 10° Brix (p-value 0.07).

Syrup 1-1, containing 333 ppm of Material B and Rebaudioside A used as flavors to create a more sugar-like taste profile in the ratio of 2.96:1, was significantly less sweet than Material C at 10° Brix (p-value<0.01).

### Example 2

Table 4 shows the formula of three corn syrups with lower dextrose level compared to those in Example 1. Because of low dextrose and no sucrose in the formula, the corn syrups in Table 4 by themselves would be less sweet than the one in Example 1 and therefore, the number and level of flavor enhancer was increased. The sweetness of Syrups 2-1, 2-2 and 2-3 was evaluated by comparing with Material C at 10% solids content by two expert panelists.

TABLE 4
Syrup formulas for sweetness comparison

| | % dsb | grams as is |
|---|---|---|
| Syrup 2-1 | | |
| Material D solution (74.3% | 20.000 | 19.11 |
| dsb) | | |
| Material E | 79.910 | 70.92 |
| Material B | 0.06 | 0.043 |
| Rebaudioside A | 0.03 | 0.021 |
| 1M Acetate Buffer | | 1.00 |
| H₂O | | 8.89 |
| Total | 100 | 100.00 |
| Syrup 2-2 | | |
| Material D solution (74.3% | 20.000 | 19.11 |
| dsb) | | |
| Material E | 79.933 | 70.94 |
| Material B | 0.0498 | 0.035 |
| Rebaudioside A | 0.0168 | 0.015 |
| 1M Acetate Buffer | | 1.00 |
| H₂O | | 8.90 |
| Total | 100 | 100.00 |
| Syrup 2-3 | | |
| Material A (74.5% dsb) | 20.000 | 19.06 |
| Material E | 79.940 | 70.95 |
| Material B | 0.04 | 0.028 |
| Rebaudioside A | 0.02 | 0.014 |
| Thaumatin | 0.01 | 0.007 |
| 1M Acetate Buffer | | 1.00 |
| H₂O | | 8.89 |
| Total | 100 | 100.00 |

Syrup 2-1, with 20% dsb Material D solution, 79.9% dsb Material E, 600 ppm Material B and 300 ppm Rebaudioside A, was found to be about 80% as sweet as Material C in 10% solids solution.

Syrup 2-2 with 20% dsb Material D solution, 79.9% dsb Material E, 498 ppm Material B and 168 ppm Rebaudioside A was found to be about 50% as sweet as Material C in 10% solids solution.

Syrup 3-3 with 20% dsb Material D solution, 79.9% dsb Material E, 400 ppm Material B, 200 ppm Rebaudioside A and 100 ppm Thaumatin showed similar sweetness to Material C in 10% solids solution.

Example 2 shows that it is possible to use different combinations of flavor enhancers, each under their sub-sweetening level, in less sweet syrups to increase the overall sweetness perception.

### Example 3

Three syrup blends and three existing commercial corn syrups, Material E, Material F and Material C, were prepared according to Table 5. The moisture content of each syrup was adjusted to a level similar to that of Material C. The viscosity of each syrup was checked using an Advanced Rheometer AR 2000 with steady state flow method. The shear rate was set at 50/s. The viscosity was tested at 60, 50, 37, 30 and 20° C. At each temperature, 10 data points were collected.

TABLE 5
Syrup formulas for viscosity test

| | % |
|---|---|
| Formula (dry solid basis) | solid |
| 47% Material A (74.50% dsb) + 52.94% Material F | 69.6 |
| 20% Material A (74.5% dsb) + 80% Material E | 70.04 |
| 75% Material A (74.5% dsb) + 25% sucrose | 69.98 |
| Material E | 69.39 |
| Material F | 69.64 |
| Material C | 70.3 |

Table 6 shows the viscosity values for the various syrups described in Table 5.

TABLE 6

| | Viscosity at 37° C. | Viscosity at |
|---|---|---|
| Formula (dry solids basis) | (Pa · s) | 20° C. (Pa · s) |
| 47% Material A (74.50% dsb) + | 0.12 | 0.38 |
| 52.94% Material F | | |
| 20% Material A (74.5% dsb) + | 0.13 | 0.41 |
| 80% Material E | | |
| 75% Material A (74.5% dsb) + | 0.10 | 0.32 |
| 25% sucrose | | |
| Diluted Material E | 0.12 | 0.39 |
| Diluted Material F | 0.19 | 0.70 |
| Material C | 0.07 | 0.25 |

All the corn syrup/sucrose blends had slightly higher viscosity than Material C, but the higher viscosities are not expected to lead to any processing difficulties when the syrups are used to replace high fructose corn syrup in a food or beverage composition. The diluted existing commercial corn syrup, Material F, showed significantly higher viscosity at lower temperatures than Material C, while Material E had similar viscosity to the blends.

### Example 4

Two different enhanced syrups containing sucrose were prepared for microbial stability tests:
75% dsb Material A, 25% dsb sucrose, 0.0250% dsb rebaudioside A,
0.0060% dsb Material B at 71% total solids (designated as sample C2-263)
75% dsb Material A, 25% dsb sucrose, 0.0250% dsb rebaudioside A,
0.0030% dsb NHDC at 71% total solids (designated as sample C2-262)

The syrups were stored at 95° F., 110° F., 125° F., and 160° F. and microbial stability tests were performed over time. No microbial growth was found in both syrups (C2-263 and C2-262) at 110° F. up to 7 months. Also, there was no microbial growth was found in both syrups at 95, 125 and 160° F. during the storage period before the samples were discarded (Table 7). Example 4 shows that the sweetener syrup is microbial stable.

TABLE 7
Microbial stability of 2 sweetener syrups

| | | | | | | | |
|---|---|---|---|---|---|---|---|
| | | Coliform Group | E Coli | Salmonella | Total Plate Count | Mold | Yeast |
| Temp | Time | /gram | /gram | /50 grams | /gram | /gram | /gram |

C2-262

| | | | | | | | |
|---|---|---|---|---|---|---|---|
| | Day 0 | <3 | <3 | <1 | 0 | 0 | 0 |
| 160° F. | Day 1 | <3 | <3 | <1 | 0 | 0 | 0 |
| | Day 3 | <3 | <3 | <1 | 0 | 0 | 0 |
| | Day 7 | <3 | <3 | <1 | 0 | 0 | 0 |
| | Day 14 | <3 | <3 | <1 | 0 | 0 | 0 |
| 95° F. | Week 1 | <3 | <3 | <1 | 0 | 0 | 0 |
| | Week 2 | <3 | <3 | <1 | 2 | 0 | 0 |
| | Month 1 | <3 | <3 | <1 | 0 | 0 | 0 |
| 125° F. | Week 1 | <3 | <3 | <1 | 0 | 0 | 0 |
| | Week 2 | <3 | <3 | <1 | 0 | 0 | 0 |
| | Month 1 | <3 | <3 | <1 | 0 | 0 | 0 |
| 110° F. | Week 1 | <3 | <3 | <1 | 0 | 0 | 0 |
| | Week 2 | <3 | <3 | <1 | 0 | 0 | 0 |
| | Month 1 | <3 | <3 | <1 | 0 | 0 | 0 |
| | Month 3 | <3 | <3 | <1 | 0 | 0 | 0 |
| | Month 4 | <3 | <3 | <1 | 0 | 0 | 0 |
| | Month 7 | <3 | <3 | <1 | 0 | 0 | 0 |

C2-263

| | | | | | | | |
|---|---|---|---|---|---|---|---|
| | Day 0 | <3 | <3 | <1 | 1 | 0 | 0 |
| 160° F. | Day 1 | <3 | <3 | <1 | 0 | 0 | 0 |
| | Day 3 | <3 | <3 | <1 | 0 | 0 | 0 |
| | Day 7 | <3 | <3 | <1 | 0 | 0 | 0 |
| | Day 14 | <3 | <3 | <1 | 0 | 0 | 0 |
| 95° F. | Week 1 | <3 | <3 | <1 | 0 | 0 | 0 |
| | Week 2 | <3 | <3 | <1 | 0 | 0 | 0 |
| | Month 1 | <3 | <3 | <1 | 1 | 0 | 0 |
| 125° F. | Week 1 | <3 | <3 | <1 | 0 | 0 | 0 |
| | Week 2 | <3 | <3 | <1 | 0 | 0 | 0 |
| | Month 1 | <3 | <3 | <1 | 0 | 0 | 0 |
| 110° F. | Week 1 | <3 | <3 | <1 | 2 | 0 | 0 |
| | Week 2 | <3 | <3 | <1 | 0 | 0 | 0 |
| | Month 1 | <3 | <3 | <1 | 0 | 0 | 0 |
| | Month 3 | <3 | <3 | <1 | 5 | 0 | 0 |
| | Month 4 | <3 | <3 | <1 | 0 | 0 | 0 |
| | Month 7 | <3 | <3 | <1 | 0 | 0 | 0 |

### Example 5

Tests were carried out as described in Example 5, 6, and 7 to determine the effect of varying the composition of a syrup on its crystallization behavior. The syrups did not contain flavor enhancer, but could be modified as desired and as described herein with one or more flavor enhancers in order to increase their perceived sweetness.

Material A (˜74% dry solids content) was mixed with various other substances as described in Table 7. The sum of % DSB (dry solids base) of the additional substances and Material A was 100%. The solids content of final syrups was targeted at 71%. “RSCS” is reduced sugar corn syrup, prepared by enzymatic hydrolysis of corn starch to provide a syrup having a relatively low content of mono- and di-saccharides as well as a relatively low content of saccharides having a DP value greater than 10 and a relatively high content of DP3-DP10 saccharides.

TABLE 8
Syrup compositions in Example 5

| Sample | | | | |
|---|---|---|---|---|
| ID | Additional Substance | Material A | | Temperatures |
| 7-1 | Sucrose monopalmitate, | 99.993% | DSB | 25° C., 37° C. |
| | 0.007% DSB | | | |
| 7-2 | Sucrose monopalmitate, | 99.9718% | DSB | 25° C., 37° C. |
| | 0.0282% DSB | | | |
| 7-3 | Material G, 0.7% DSB | 99.3% | DSB | 25° C., 37° C. |
| 7-4 | Material G, 2.8% DSB | 97.2% | DSB | 25° C., 37° C. |
| 7-5 | RSCS, 2.8% DSB | 97.2% | DSB | 25° C., 37° C. |
| 7-6 | RSCS, 14% DSB | 86% | DSB | 25° C., 37° C. |
| 7-7 | Material F, 2.8% DSB | 97.2% | DSB | 25° C., 37° C. |
| 7-8 | Material F, 14% DSB | 86% | DSB | 25° C., 37° C. |
| 7-9 | Material H, 2.8% DSB | 97.2% | DSB | 25° C., 37° C. |
| 7-10 | Material H, 14% DSB | 86% | DSB | 25° C., 37° C. |
| 7-11 | Material E, 2.8% DSB | 97.2% | DSB | 25° C., 37° C. |
| 7-12 | Material E, 14% DSB | 86% | DSB | 25° C., 37° C. |

All the samples in Table 8 were prepared in 1000 grams total and were then divided into 4 glass jars with 250 grams of solution in each jar. The jars were heated at 80° C. for 0.5 hours and cooled down to the final storage temperatures overnight (2 jars at 25° C. and 2 jars at 37° C.). To facilitate the crystallization process, about 0.01 grams of Material D was placed in one jar from each sample at each temperature (seeded). The jars without Material D (unseeded) were used as reference samples. The crystallization of each sample was determined by measuring % of moisture in the solution using Karl Fischer titration. HPLC analysis was also used to monitor the change of dextrose (glucose) concentration in solution.

All the samples in Table 8 that were stored at 25° C. were completely crystallized after 1 month and therefore no analytical testing was done on those samples. The final dextrose solubility of the different syrup systems at 37° C. were shown in Table 9.

TABLE 9
Solubility of dextrose at 37° C. in different syrups

| | Initial dextrose content % | Final dextrose content % |
|---|---|---|
| Sample ID | (dextrose/(dextrose + water)) | (dextrose/(dextrose + water)) |
| 7-1 | 69.12 | 59.35 |
| 7-2 | 68.94 | 57.70 |
| 7-3 | 68.44 | 63.43 |
| 7-4 | 69.50 | 62.47 |
| 7-5 | 68.70 | 60.47 |
| 7-6 | 66.54 | 62.88 |
| 7-7 | 68.96 | 60.93 |
| 7-8 | 66.43 | 61.28 |
| 7-9 | 71.02 | 55.16 |
| 7-10 | 66.14 | 57.89 |
| 7-11 | 68.99 | 60.17 |
| 7-12 | 67.64 | 60.68 |

The results in Table 9 showed that after 1 month storage at 37° C., most syrups from Example 5 lost some dextrose from the initial solution and the final dextrose solubility was around 61%.

### Example 6

Based on the above experimental results, 17 more samples were prepared following the similar steps above (Table 10). The solubility of dextrose in these samples at 37° C. was shown in Table 11.

TABLE 10
Syrup compositions in Example 6

| Sample | | | |
|---|---|---|---|
| ID | Additional Substance | Material A | Temperatures |
| 8-1 | Xylose, 14% DSB | 86% DSB | 37° C. |
| 8-2 | Xylose, 35% DSB | 65% DSB | 37° C. |
| 8-3 | Xylose, 15% DSB | 85% DSB | 37° C. |
| 8-4 | Xylose, 25% DSB | 75% DSB | 37° C. |
| 8-5 | Erythritol, 14% DSB | 86% DSB | 37° C. |
| 8-6 | Erythritol, 35% DSB | 65% DSB | 37° C. |
| 8-7 | Material F, 35% | 65% DSB | 37° C. |
| | DSB | | |
| 8-8 | Material F, 20% | 80% DSB | 37° C. |
| | DSB | | |
| 8-9 | Material F, 25% | 75% DSB | 37° C. |
| | DSB | | |
| 8-10 | Material H, 35% | 65% DSB | 37° C. |
| | DSB | | |
| 8-11 | Material H, 20% | 80% DSB | 37° C. |
| | DSB | | |
| 8-12 | Material H, 25% | 75% DSB | 37° C. |
| | DSB | | |
| 8-13 | Material E, 35% DSB | 65% DSB | 37° C. |
| 8-14 | Maltose, 5% DSB | 95% DSB | 37° C. |
| 8-15 | Maltose, 10% DSB | 90% DSB | 37° C. |
| 8-16 | 20% DSB Sucrose + | 70% DSB | 37° C. |
| | 10% DSB Material F | | |
| 8-17 | 15% DSB Sucrose + | 75% DSB | 37° C. |
| | 10% DSB Material F | | |

TABLE 11
Solubility of dextrose in different syrups at 37° C. from Example 6

| | Initial dextrose content % | Final dextrose content % |
|---|---|---|
| Sample ID | (dextrose/(dextrose + water) | (dextrose/(dextrose + wat |
| 8-1 | 70.95 | 65.97 |
| 8-2 | 70.26 | 60.83 |
| 8-3 | 69.94 | 62.35 |
| 8-4 | 70.99 | 63.24 |
| 8-5 | 69.94 | 67.68 |
| 8-6 | 70.29 | 58.16 |
| 8-7 | 63.48 | 59.76 |
| 8-8 | 71.46 | 56.34 |
| 8-9 | 71.32 | 54.25 |
| 8-10 | 62.66 | 61.80 |
| 8-11 | 69.15 | 59.16 |
| 8-12 | 73.86 | 53.26 |
| 8-13 | 65.68 | 63.83 |
| 8-14 | 72.18 | 58.89 |
| 8-15 | 71.15 | 59.03 |
| 8-16 | 73.773 | 63.927 |
| 8-17 | 71.586 | 61.656 |

Like in Example 5, after 1 month storage at 37° C., most syrups from Example 6 lost some dextrose from initial solution and the final dextrose solubility was around 61%-64%. The most stable syrup was the syrup with 14% erythritol and xylose. However, erythritol and xylose are relatively expensive and thus impractical to be used as a replacement for HFCS. An alternative solution is to use Material E or a combination of sucrose and Material F as a stabilizer (anti-crystallization agent) for dextrose at 37° C., as long as the dextrose solubility is maintained below 64% (dextrose/(dextrose+water)).

### Example 7

Since all the above samples crystallized at 25° C., a third set of samples (Example 7) was prepared using DOE of mixture design. The design summary is shown in Table 12.

TABLE 12
Design summary

| | | | |
|---|---|---|---|
| Design | | | |
| Summary | | | |
| Study Type | Mixture | | |
| Design | Simplex | Runs | 20 |
| Type | Lattice | Blocks | No Blocks |

| | Component | | | | | Low | High |
|---|---|---|---|---|---|---|---|
| | Name | Units | Type | Minimum | Maximum | Actual | Actual |
| | Material A | % | Mixture | 10 | 70 | 10 | 70 |
| | Material F | % | Mixture | 10 | 70 | 10 | 70 |
| | Material H | % | Mixture | 10 | 70 | 10 | 70 |
| | Sucrose | % | Mixture | 10 | 70 | 10 | 70 |
| | | | | Total = | 100 | | |
| Respnse | Name | Units | Obs | Analysis | Minimum | Maximum | Mean |
| Y1 | Dextrose | A% | 20 | Polynomial | 22.25 | 28.75 | 27.391 |

The syrup compositions in Example 7 are shown in Table 13. Each syrup was prepared in two 100 gram glass jars. Each syrup also contained 10 mM acetate buffer to maintain pH at 5.5.

TABLE 13
Syrup compositions in Example 7

| | | | | Component |
|---|---|---|---|---|
| | Component 1 | Component 2 | Component 3 | 4 |
| | Material A | Material F | Material H | Sucrose |
| Sample | % DSB | % DSB | % DSB | % DSB |
| 10-1 | 40 | 40 | 10 | 10 |
| 10-2 | 10 | 10 | 70 | 10 |
| 10-3 | 70 | 10 | 10 | 10 |
| 10-4 | 40 | 10 | 10 | 40 |
| 10-5 | 47.5 | 17.5 | 17.5 | 17.5 |
| 10-6 | 17.5 | 47.5 | 17.5 | 17.5 |
| 10-7 | 10 | 10 | 10 | 70 |
| 10-8 | 17.5 | 17.5 | 17.5 | 47.5 |
| 10-9 | 17.5 | 17.5 | 47.5 | 17.5 |
| 10-10 | 10 | 40 | 10 | 40 |
| 10-11 | 10 | 70 | 10 | 10 |
| 10-12 | 25 | 25 | 25 | 25 |
| 10-13 | 10 | 10 | 70 | 10 |
| 10-14 | 10 | 40 | 40 | 10 |
| 10-15 | 10 | 70 | 10 | 10 |
| 10-16 | 40 | 40 | 10 | 10 |
| 10-17 | 10 | 10 | 40 | 40 |
| 10-18 | 70 | 10 | 10 | 10 |
| 10-19 | 40 | 10 | 40 | 10 |
| 10-20 | 10 | 10 | 10 | 70 |

After the formulas were completely mixed, pH was checked. Saccharide distribution in each syrup was determined using an HPLC method. The viscosity of the syrup was measured using an Advance Rheometer™ AR 2000 with 40 mm crosshatched steel plate. The viscosity was measured at 60, 50, 37, 30 and 20° C. at 25/s shear rate. At each temperature, 10 data points were collected and the average was calculated. The syrups were then heated to 80° C. for 30 minutes to erase any nuclei and then cooled at 25° C. overnight before adding 0.01% Material D powder in one jar of each sample. The samples without Material D were used as reference.

Although food processors generally have jacketed tanks on site to keep syrups warm during storage, many prefer to employ syrups which are stable (crystallization resistant) at room temperature. Therefore, it is highly desirable to develop syrups having better stability at lower temperatures. Table 14 summarizes the results of Example 7, which was designed to evaluate dextrose crystallization stability with other ingredients at 25° C.

TABLE 14
Solubility of dextrose in different syrups at 25° C. (Example 7)

| | Initial dextrose content % | Final dextrose content % |
|---|---|---|
| Sample | (dextrose/(dextrose + water)) | (dextrose/(dextrose + water)) |
| 10-1 | 53.91 | 50.51 |
| 10-2 | 36.00 | 32.02 |
| 10-3 | 66.17 | 0.00 |
| 10-4 | 51.91 | 51.18 |
| 10-5 | 55.33 | 53.62 |
| 10-6 | 40.86 | 36.31 |
| 10-7 | 28.74 | 25.69 |
| 10-8 | 36.48 | 35.40 |
| 10-9 | 37.56 | 38.43 |
| 10-10 | 36.88 | 35.56 |
| 10-11 | 31.60 | 31.95 |
| 10-12 | 42.82 | 38.96 |
| 10-13 | 30.35 | 32.57 |
| 10-14 | 31.31 | 28.03 |
| 10-15 | 30.77 | 30.47 |
| 10-16 | 52.54 | 52.26 |
| 10-17 | 28.19 | 24.99 |
| 10-18 | 62.60 | 0.00 |
| 10-19 | 53.26 | 48.74 |
| 10-20 | 26.16 | 24.54 |

Table 14 shows that most of the syrups had dextrose solubility about 53% or below at 25° C. The two syrups with initial high dextrose levels (10-3 and 10-18) were completely crystallized at 25° C. and could not be analyzed. Even though most syrups in Table 14 (except 10-3 and 10-18) were clear visually, some of them did have viscosity buildup. Table 15 shows the viscosity of these syrups at 20° C.

TABLE 15
Viscosity of syrups from Experiment 3 at 20° C.

| | Moisture | Viscosity at 20° C. |
|---|---|---|
| Sample | % | Pa · S |
| 10-1 | 26.97 | 0.203 |
| 10-2 | 22.25 | 12.1 |
| 10-3 | 26.02 | 0.57 |
| 10-4 | 27.69 | 0.7 |
| 10-5 | 28.07 | 0.9 |
| 10-6 | 27.49 | 1.15 |
| 10-7 | 25.73 | 2.1 |
| 10-8 | 27.86 | 1.05 |
| 10-9 | 28.42 | 1.35 |
| 10-10 | 27.07 | 1.1 |
| 10-11 | 28.05 | 1.4 |
| 10-12 | 27.59 | 1.3 |
| 10-13 | 27.93 | 5.8 |
| 10-14 | 27.64 | 2.3 |
| 10-15 | 28.54 | 1.26 |
| 10-16 | 28.2 | 0.67 |
| 10-17 | 27.98 | 1.9 |
| 10-18 | 28.75 | 0.51 |
| 10-19 | 27.01 | 1.3 |
| 10-20 | 28.56 | 0.69 |

Table 15 shows the viscosity of syrups made with Material A, Material F, Material H and sucrose at 20° C. Although all the samples were prepared with targeted solid content ˜71% (moisture ˜29%), sample 10-2 in Table 15 had particularly low moisture. This could be due to the experimental variation, because 10-13 (which had the same composition as 10-2) showed moisture content at ˜28%. Nevertheless, sample 10-2 had the lowest moisture content which in turn had the highest viscosity. Besides moisture, the content of higher molecular weight components also plays an important role in controlling viscosity. Sample 10-13 had a viscosity of 5.8 Pa·S. It had the largest amount of Material H, which contains about 26% higher molecular weight saccharides. Samples containing mostly lower molecular weight saccharides showed lower viscosity (samples 10-1, 10-3, 10-4, 10-5, 10-16, 10-18 and 10-20). However, since samples 10-3 and 10-18 were completely crystallized at 25° C., they are not considered suitable for use as potential HFCS 42 replacements where the syrup is to be stored at lower temperatures.

1. A sweetener syrup comprising water and glucose and having a dry solids content of from 69% to 73% by weight, additionally comprising an amount of stabilizer selected from the group consisting of DP2 to DP10 saccharides, sugar alcohols, and monosaccharides other than glucose and mixtures thereof effective to inhibit crystallization of the sweetener syrup and an amount of one or more flavor enhancers effective to increase the perceived sweetness of the sweetener syrup, wherein the sweetener syrup is comprised of from 0 to not more than 5 weight % fructose on a dry solids basis.

2. The sweetener syrup of claim 1, wherein the stabilizer content of the sweetener syrup is from 25 to 60 weight % of the glucose and stabilizer combined.

3. The sweetener syrup of claim 1, wherein the glucose content of the sweetener syrup is from 40 to 75 weight % of the glucose and stabilizer combined.

4. The sweetener syrup of claim 1, wherein the stabilizer is sucrose.

5. The sweetener syrup of claim 1, wherein the stabilizer is selected from the group consisting of sucrose, maltose, maltotriose, maltotetraose and mixtures thereof.

6. The sweetener syrup of claim 1, wherein the stabilizer is a sugar alcohol or mixture of sugar alcohols.

7. The sweetener syrup of claim 1, wherein the stabilizer is a DP2 to DP10 saccharide or mixture of DP2 to DP10 saccharides.

8. The sweetener syrup of claim 1, wherein the stabilizer is xylose.

9. The sweetener syrup of claim 1, wherein the sweetener syrup has a viscosity at 20° C. of 0.2 to 0.45 Pa·s and a viscosity at 37° C. of 0.05 to 0.15 Pa·s.

10. The sweetener syrup of claim 1, wherein the one or more flavor enhancers comprise compounds selected from the group consisting of mogrosides, steviol glycosides, glycosylated steviol glycosides, neohesperidin dihydrochalcone, neotame, glycyrrhizin, glycyrrhizin salts, glycyrrhizin derivatives, rubusoside, and mixtures thereof.

11. The sweetener syrup of claim 1, wherein the one or more flavor enhancers comprise mogroside V and rebaudioside A.

12. The sweetener syrup of claim 1, wherein the sweetener syrup comprises a total of less than 10 weight % on a dry solids basis of saccharides having a DP value of 11 or greater.

13. The sweetener syrup of claim 1, wherein the sweetener syrup comprises a total of from 0.001 to 2 weight %, on a dry solids basis, of flavor enhancer.

14. The sweetener syrup of claim 1, wherein the sweetener syrup is comprised of not more than 1 weight % fructose on a dry solids basis.

15. A food, beverage or pharmaceutical composition comprising the sweetener syrup of claim 1 and at least one additional food, beverage or pharmaceutical ingredient.

16. A method of making a sweetener syrup, comprising combining one or more stabilizers selected from the group consisting of DP2 to DP10 saccharides, sugar alcohols and monosaccharides other than glucose and one or more flavor enhancers with a glucose syrup, wherein an amount of stabilizer is used which is effective to inhibit crystallization of the sweetener syrup, an amount of flavor enhancer is used which is effective to increase the perceived sweetness of the sweetener syrup, and the resulting sweetener syrup has a dry solids content of 69% to 73% by weight and is comprised of from 0 to not more than 5 weight % fructose on a dry solids basis.
